(19) United States
(12) Patent Application Publication
(10) Pub. No.: US 2008/0266726 A1
(43) Pub. Date: Oct. 30, 2008

(54) Cooling system for electrical devices

(76) Inventors: Vance Murakami, Cupertino, CA (US); Christian L. Belady, McKinney, TX (US); Paul L. Perez, Magnolia, TX (US); Robert A. Pereira, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/796,402

(22) Filed: Apr. 27, 2007

(51) Int. Cl. H02H 7/20

(52) U.S. Cl. 361/1

(57) ABSTRACT

Embodiments include a server and a sensor that detects when a first fluid line to the server fails so a second fluid line to the server is activated.

### BACKGROUND

Densification in data centers is becoming so extreme that the power density of the systems in the center is growing at a rate unmatched by technological developments in data center heating, ventilation, and air-conditioning (HVAC) designs. Current servers and disk storage systems, for example, generate thousands of watts per square meter of footprint. Telecommunication equipment generates two to three times the heat of the servers and disk storage systems.

Computer designers are continuing to invent methods that extend the air-cooling limits of individual racks of computers (or other electronic heat-generating devices) that are air-cooled. High heat capacity racks, however, require extraordinary amounts of air to remove the heat dissipated by the racks and use expensive and large air handling equipment.

Some electrical devices, such as liquid-cooled mainframe computers, do use liquid cooling. In some situations, liquid cooling provides significant improvements over air-cooled systems. For instance, liquid cooling can more effectively remove large amounts of heat from data centers or even single servers.

Prior liquid cooling systems, however, are not fault tolerant. In other words, a server or data center can unexpectedly shutdown if a failure occurs with the cooling system. For example, if the cooling line in a building fails, then a single server or an entire data center will not be sufficiently cooled. As such, the server or entire data center can overheat and shutdown. As another example, if a non-fault tolerant cooling system needs serviced, then all servers or data centers on this cooling system would be temporarily shutdown while the system is repaired.

### BRIEF DESCRIPTION OF THE DRAWINGS

FIG. 1 is a cooling system in accordance with an exemplary embodiment.

FIG. 2 is another cooling system in accordance with an exemplary embodiment.

FIG. 3 is another cooling system in accordance with an exemplary embodiment.

FIG. 4 is an electrical device in accordance with an exemplary embodiment.

FIG. 5 shows an example location for a liquid transfer switch in accordance with an exemplary embodiment.

FIG. 6 shows another example location for a liquid transfer switch in accordance with an exemplary embodiment.

FIG. 7 shows another example location for a liquid transfer switch in accordance with an exemplary embodiment.

FIG. 8 shows another example location for a liquid transfer switch in accordance with an exemplary embodiment.

FIG. 9 is a flow diagram of an exemplary algorithm in accordance with an exemplary embodiment.

### DETAILED DESCRIPTION

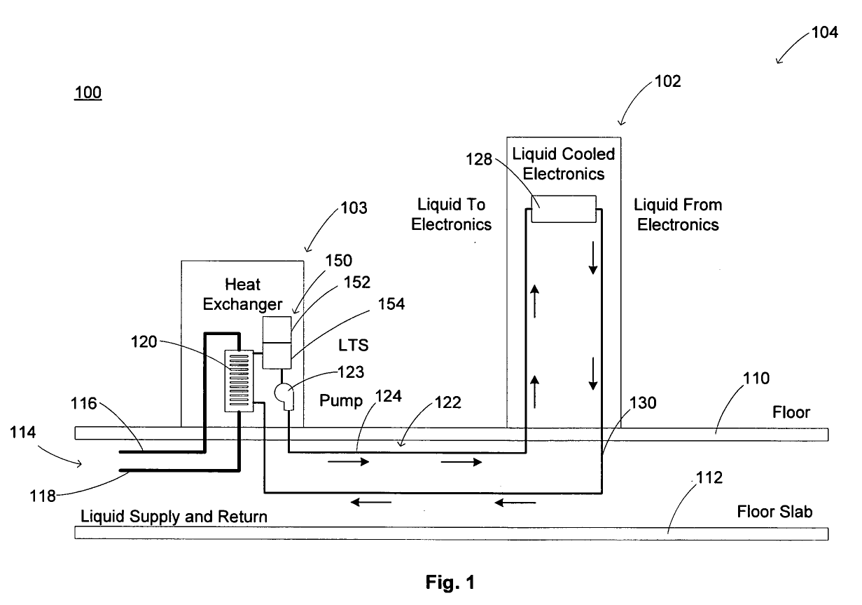

FIG. 1 shows a partial side-view of a cooling system 100 for cooling one or more electronic devices 102. The cooling system includes one or more coolant converters or liquid cooling units 103 for cooling one or more computers (such as computer racks or plural vertically stacked servers) in a data center 104. For illustration, the data center 104 is shown with an electronic device 102 (example, single server), but multiple servers, computers, and other electronic devices can also be present and cooled with the cooling system.

The data center 104 is situated in a building or room that has a floor 110 above a floor slab 112. A network of pipes 114 extends between the floor 110 and floor slab 112. The pipes carry a cooling fluid to and from the liquid cooling unit 103 and the electronic device 102. By way of example, the cooling fluids include, but are not limited to, water, refrigerant, single phase fluids, two phase fluids, etc. Further, although the pipes are shown within the floor, they can be located in various places, such as, but not limited to, the ceiling, the walls, on top of the floor, underground, etc.

As shown, fluid initially enters the liquid cooling unit 103 along one or more supply lines 116 and exits the liquid cooling unit along one or more return lines 118. Specifically, the fluid passes into a heat exchanger 120, such as a liquid-to-liquid heat exchanger. This heat exchanger 120 is connected to a liquid cooling loop 122 that extends between the liquid cooling unit 103 and the electronic device 102. A pump 123 pumps the fluid along one or more supply lines 124 from the heat exchanger 120 to heat generating components or electronics 128. After cooling the electronics 128, the fluid is pumped along one or more return lines 130 back to the heat exchanger 120.

The electronics 128 generate heat that is removed by the fluid and transferred away through the return line 130. In turn, the heat exchanger 120 removes, dissipates, and/or exchanges this heat so cooled fluid pumped along the supply line 124 can remove heat from the electronics 128. Embodiments in accordance with the present invention are not limited to any particular type of heat exchanger 128. Various types of heat exchangers, now known or developed in the future, are applicable with embodiments of the invention. By way of example, the heat exchanger 128 can use one or more of thermal dissipation devices, heat pipes, heat spreaders, refrigerants, heat sinks, liquid cold plates or thermal-stiffener plates, evaporators, refrigerators, thermal pads, air flows, and/or other devices adapted to remove or dissipate heat.

In one exemplary embodiment, the cooling system 100 is fault tolerant since two or more independent or alternative fluid paths are provided to cool the electronic device 102. For example, if one or more of the supply lines 116/124 or return lines 118/130 breaks, fails, needs serviced, or otherwise shuts-down, then the electronic device 102 (example, servers or racks in data center 104) will not immediately or contemporaneously overheat and shutdown. In the event of such a failure or servicing in the cooling system 100, the liquid cooling loop 122 extending between the liquid cooling unit 103 and the electronic device 102 continues to cool the electronics 128 using an alternative or redundant supply and return lines.

One exemplary embodiment uses a combination of a liquid transfer switch (LTS) and one or more redundant supply lines and return lines to provide fault tolerance for cooling system 100. For simplicity of illustration, FIGS. 1-3 show a single line as a supply line and a single line as a return line. Each of these lines, however, includes one or more lines to provide redundant cooling. Looking to FIG. 1 for example, supply lines 116 include two or more independent lines (example, pipes) for supplying fluid, and return lines 118 include two or more independent lines (example, pipes) for returning fluid. Redundancy of lines can also occur between the liquid cooling unit 103 and electronic device 102. For example, supply lines 124 include two or more independent lines (example, pipes) for supplying fluid, and return lines 130 include two or more independent lines (example, pipes) for returning fluid.

In one embodiment, the liquid transfer switch 150 includes one or more sensors 152 and valves 154. The liquid transfer switch provides an automated mechanism to manage fluid flow to and from the electronic device. The sensor 152 senses one or more conditions in the system in order to actuate (example, open or close) the one or more valves 154.

In one embodiment, one or more components in the heat exchanger 103 are controlled with an algorithm. For instance, information from the sensor 152 is used to open and control the valves 154 to regulate fluid flow to and from the electronic device 102.

One embodiment consists of using a mechanical valve that is controlled by the algorithm. When a failure occurs, the algorithm activates one or more valves to maintain continuous fluid supply to the electronic device. For example, if one of the supply or return lines fail, then the alternate or redundant supply or return line is utilized so cooling to the electronic device is not disrupted. The electronic device thus continuously operates and/or remains online while a fluid flow path to the electronic device is altered or adjusted. In one embodiment, the alternate or redundant supply or return line is opened to provide fluid. Alternatively, if the alternate or redundant supply or return line were already open, then fluid flow can be increased if necessary to compensate for loss flow through the failed line.

By way of example, failure includes, but is not limited to, loss or disruption of electrical power in the cooling system, loss of pressure in a liquid line, pump failure, chiller failure, loss in temperature control or any other failure that can shut down or put the supply fluid out of tolerance.

In one embodiment, the valve 154 can be open, semi-open or closed, and the liquid transfer switch monitors or senses the fluid in the multiple supply and return lines. By way of example, sensing is performed using one or more of fluid flow or flow rate, fluid pressure, fluid temperature, etc.

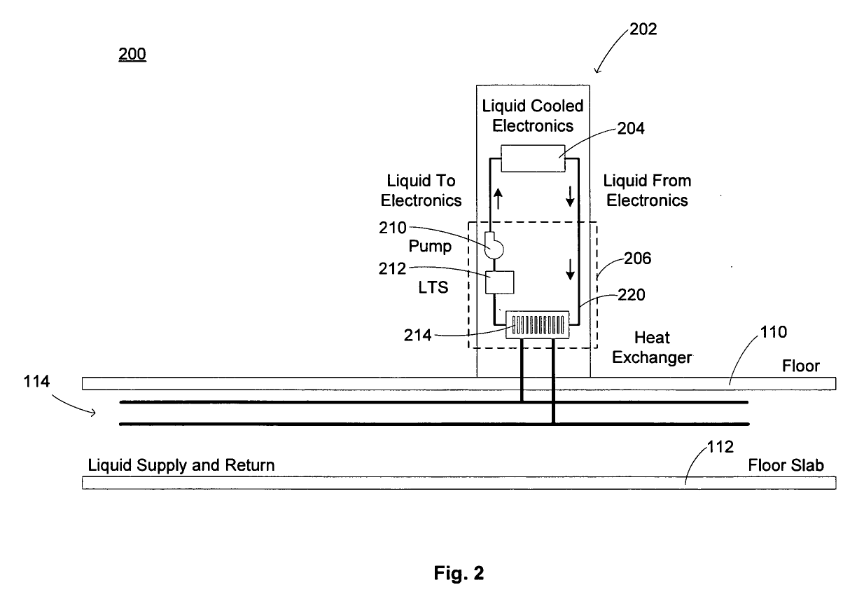

In FIG. 1, the liquid cooling unit 103 is modular and remotely located from the electronic device 102. An internal liquid cooling loop 122 extends between the liquid cooling unit and the electronic device. In alternate embodiments, the liquid cooling unit is modular and located within the electronic device(s). In such embodiments, the liquid cooling loop is within the rack, server, or computer. FIG. 2 shows one such exemplary embodiment.

FIG. 2 shows a cooling system 200 having a server or rack 202 with internal electronics 204 and an internal coolant converter unit or liquid cooling unit (shown with dashed lines 206). The liquid cooling unit includes a pump 210, a liquid transfer switch 212, and a heat exchanger 214. An internal liquid cooling loop 220 extends between the liquid cooled electronics 204 and the heat exchanger 214.

In one exemplary embodiment, the liquid cooling unit 206 is modular and a self-contained unit. For example, the liquid cooling unit is removable, serviceable, and replaceable into and out of the server 202.

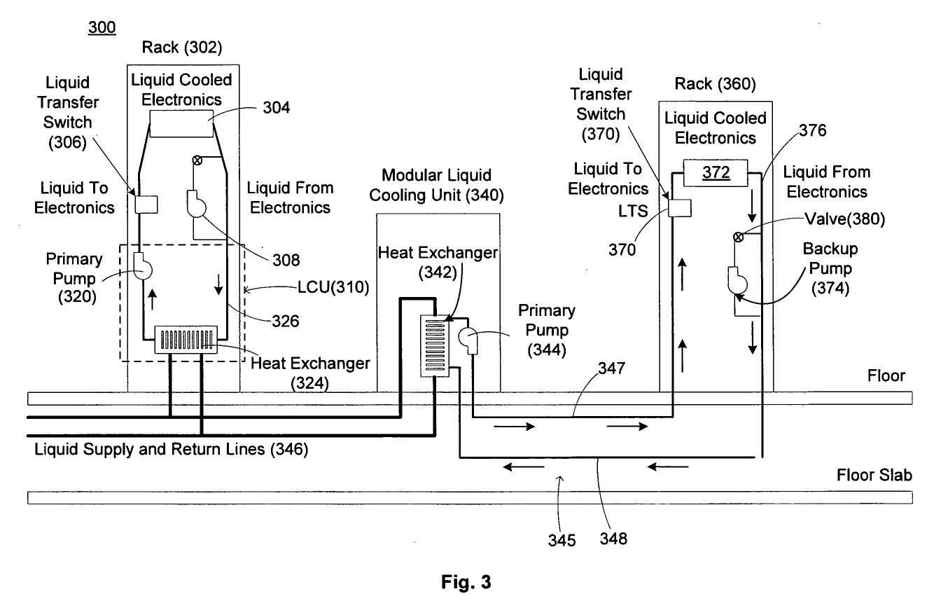

FIG. 3 shows another exemplary embodiment having a cooling system 300 that utilizes both external liquid cooling (as described in connection with FIG. 1) and internal liquid cooling (as described in connection with FIG. 2). As shown, a first rack 302 includes internal electronics 304, a liquid transfer switch 306, a pump 308, and a liquid cooling unit (LCU) 310. The liquid cooling unit includes a primary pump 320 and a heat exchanger 324. A secondary or backup pump 308 is provided in the event the primary pump fails. An internal liquid cooling loop 326 provides a fluid pathway between the internal cooling system and electronics in the rack 302.

As noted, the liquid cooling unit and/or liquid transfer switch can be modular. As such, the rack 302 can continue to operate while the liquid cooling unit 310 or liquid transfer switch 306 is serviced, replaced, or otherwise repaired. For example, if the primary pump 320 or heat exchanger 324 is temporary shutdown or otherwise fails, the liquid transfer switch 306 senses the failure and automatically actuates the second pump to maintain uninterrupted fluid flow to the rack 302.

A modular liquid cooling unit 340 includes a heat exchanger 342 and a primary pump 344. As shown, the liquid supply and return lines 346 connect to both the rack 302 and liquid cooling unit 340. A liquid cooling loop 345 includes a supply line 347 and a return line 348 that circulate fluid to a second rack 360.

The rack 360 includes a liquid transfer switch 370, liquid cooled electronics 372, and a backup pump 374. Plural valves 380 and couplings 382 are used to actuate fluid flow through the secondary pump 374.

In one exemplary embodiment, the primary pump 344 pumps fluid to cool the electronics 372 during normal operations. When the LTS 370 detects a failure, valves 380 are opened and backup pump 374 is activated. Coolant or fluid continues to circulate in rack 360 to cool electronics 372.

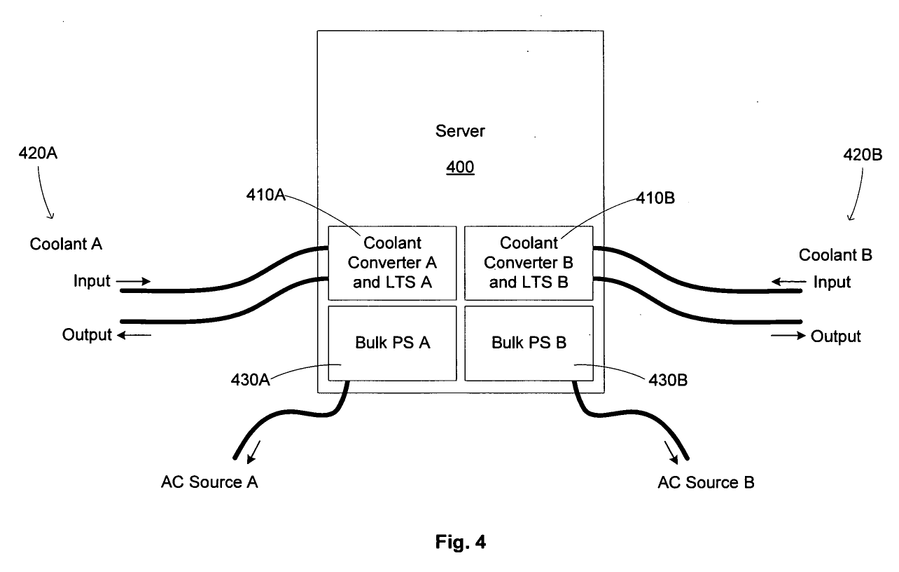

FIG. 4 shows electronics or a server 400 having multiple internal and modular redundant liquid cooling units or coolant converters 410A and 410B each having a separate independent liquid transfer switch. The server uses two independent input coolant lines for cooling. Input and output coolant lines 420A are connected to coolant converter 410A, and input and output coolant lines 420B are connected to coolant converter 410B. In one embodiment, each coolant converter includes a separate liquid transfer switch. In another embodiment, the coolant converters share one or more liquid transfer switches.

The coolant converters receive source or building coolant (such as water, refrigerant, air, compressed air, coolanol or any other generally accepted coolant known in the art) and convert it to the desired coolant (such as water, refrigerant, air, compressed air, coolanol or any other generally accepted coolant know in the art) for internal use to the computer or computer system. For example, each coolant converter forms part of a separate and independent cooling loop. These coolant converters 410A and 410B perform several functions. First, they isolate internal electrical parts or components of the server from unconditioned building coolant. Second, they allow the server manufacturer to select an optimum cooling media internal to their equipment while using building coolant or other coolant supplies. Third, they control internal coolant temperatures, flow rates, and quality of the fluid that touches or cools the internal electrical parts or components of the server. Fourth, in conjunction with one or more liquid transfer switches, they provide redundant cooling to the server 400. For example, the liquid transfer switch can switch cooling load from one coolant converter to another and/or adjust the amount of cooling load at each coolant converter in response to a failure.

The coolant converters 410A and 410B can utilize a redundant power supply, such as a dual grid power system coupled to the server 400. As shown, the server uses two independent power supplies, a bulk power supply A (430A) and bulk power supply B (430B). Specifically, power supply 430A couples to coolant converter 410A, and power supply 430B couples to coolant converter 410B. Each power supply has an independent power source, shown as alternating current AC source A for power supply 430A and AC source B for power supply 430B. The electronics and pumps of coolant converter 410A are powered from power supply 430A, while the electronics and pumps of coolant converter 410B are powered from power supply 430B.

Thus, the server 400 has both redundant power supplies and redundant cooling systems, and redundant sensing of fluid conditions using redundant liquid transfer switches. In one exemplary embodiment, the coolant converters 410A and 410B are identical. In another exemplary embodiment, the coolant converters are different (example, one is a primary coolant converter and one is a backup coolant converter). Further, one coolant converter is a liquid converter and one coolant converter is or utilizes air cooling. Further, since coolants A and B are independent and input separately, these coolants can be the same (example, both water or both refrigerants) or different.

FIG. 4 shows the coolant converters 410A and 410B located above their respective power supplies 430A and 430B. In alternative embodiments, the coolant converters are at the bottom of the server, and the power supplies are above the coolant converters. In this alternate embodiment, liquid connections are below the electronics during an accidental leak. Also, the coolant converters can be combined into a single unit or kept separate so they can be individually serviced and replaced. With this dual and redundant cooling and powering system, the server continues to run while one of the coolant converters fails or otherwise is shutdown.

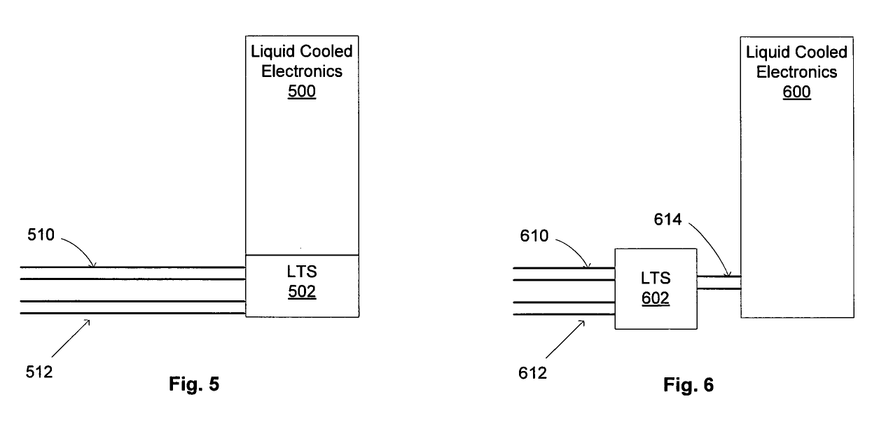

The liquid transfer switch can be located in various locations in accordance with exemplary embodiments. By way of example, the switch can be located in or near the rack, in or on the data center floor, in the heat exchanger, any location in the date center, or any location remote from the data center. FIGS. 5-8 illustrate some exemplary locations for the liquid transfer switch.

FIG. 5 shows an example location for a liquid transfer switch in accordance with an exemplary embodiment. An electronic device 500 (such as a server or rack) includes a liquid transfer switch 502 that is internal or proximate to the electronic device. Dual independent fluid lines 510 and 512 provide redundant cooling to the electronic device.

FIG. 6 shows another example location for a liquid transfer switch in accordance with an exemplary embodiment. An electronic device 600 (such as a server or rack) couples or connects to a liquid transfer switch 602. By way of example, the electronic device and liquid transfer switch are in a same room or same data center. Dual independent fluid lines 610 and 612 provide redundant cooling to the liquid transfer switch 602, and one or more fluid line 614 couple between the liquid transfer switch 602 and electronic device 600.

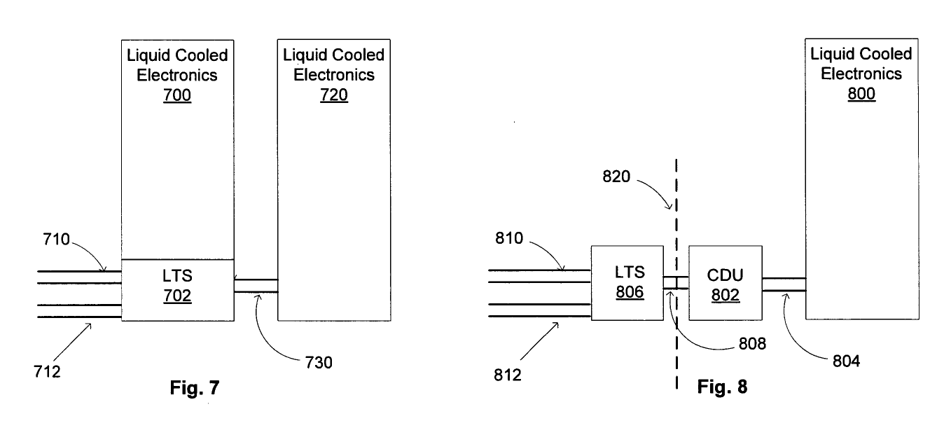

FIG. 7 shows another example location for a liquid transfer switch in accordance with an exemplary embodiment. A first electronic device 700 (such as a server or rack) includes a liquid transfer switch 702 that is internal or proximate to the electronic device. Dual independent fluid lines 710 and 712 provide redundant cooling to the electronic device 700. A second electronic device 720 connects to the liquid transfer switch 702 via one or more fluid lines 730.

FIG. 8 shows an example location for a liquid transfer switch in accordance with an exemplary embodiment. An electronic device 800 (such as a server or rack) connects to a modular liquid cooling unit or coolant distribution unit (CDU) 802 via one or more fluid lines 804. The CDU in turn connects to a liquid transfer switch 806 via one or more fluid lines 808. Dual independent fluid lines 810 and 812 provide redundant cooling to the liquid transfer switch. The liquid transfer switch is physically separated (shown with dashed line 820) from the CDU 802 and electronic device 800 (example, located in the separate room or remote location). In one embodiment, the CDU 802 controls and conditions liquid and is used to ensure correct flow rate and temperature for the electronics in the electronic device 800.

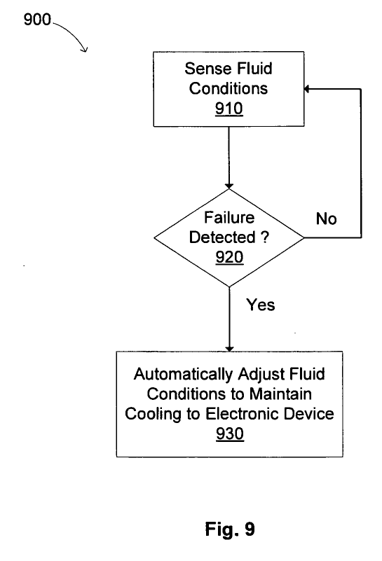

FIG. 9 shows a flow diagram of an exemplary algorithm 900 according to one embodiment. According to block 910, fluid conditions are sensed. By way of example, one or more sensors are used to sense fluid conditions such as temperature, pressure, flow rate, etc.

According to block 920, a question is asked whether a failure is detected. If the answer to this question is “no” then flow proceeds back to block 910. If the answer to this question is “yes” then flow proceeds to block 930. By way of example, a sensor senses one or more conditions to indicate a failure with respect to temperature, pressure, flow rate, etc.

According to block 930, the fluid condition is automatically adjusted to maintain cooling to the electronic device. When a failure occurs, opens or closes one or more valves to a redundant fluid line to maintain continuous fluid supply to the electronic device. For example, if one of the supply or return lines fail, then the alternate or redundant supply or return line is opened or adjusted (example, flow rate increased) so cooling to the electronic device is not disrupted.

Although embodiments in accordance with the present invention are generally directed to liquid cooling systems, such systems can also use or combine airflow for cooling. For example, active heatsinks include one or more fans to assist in cooling.

The liquid transfer switch is a unit that is modular and replaceable. In some embodiments, each unit or module is constructed with standardized units or dimensions for flexibility and replaceability for use in the electronic devices. As such, the units connected to or removed from the electronic devices (example, a server) without connecting, removing, or replacing other components in the electronic device (example, the heat-generating components, other liquid cooling units, other coolant converters, heat exchangers, etc.). As such, the unit can be serviced (example, replaced or repaired) without shutting down or turning off the respective electronic device (example, server housing the unit or converter).

As used herein, the term “module” means a unit, package, or functional assembly of electronic components for use with other electronic assemblies or electronic components. A module may be an independently-operable unit that is part of a total or larger electronic structure or device. Further, the module may be independently connectable and independently removable from the total or larger electronic structure (such as liquid cooling units or coolant converters being modules and connectable to servers in data centers).

In one exemplary embodiment, one or more blocks or steps discussed herein are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

The methods in accordance with exemplary embodiments of the present invention are provided as examples and should not be construed to limit other embodiments within the scope of the invention. For instance, blocks in diagrams or numbers (such as (1), (2), etc.) should not be construed as steps that must proceed in a particular order. Additional blocks/steps may be added, some blocks/steps removed, or the order of the blocks/steps altered and still be within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein (such as being implemented in a server, CDU, or liquid cooling unit). The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A system, comprising:
a server; and
a sensor that detects a failure associated with a first fluid line connected to the server so a second fluid line connected to the server is activated to provide fault-tolerant cooling to the server.

2) The system of claim 1 further comprising, a valve that automatically opens a fluid path in the second fluid line when the sensor senses the failure in the first fluid line.

3) The system of claim 1, wherein the sensor is external to the server.

4) The system of claim 1 further comprising:
a first pump for pumping fluid to the server along the first fluid line;
a second pump for pumping fluid to the server along the second fluid line, the second pump providing sufficient pumping services to cool the server when the first pump fails.

5) The system of claim 1 further comprising, a rack including plural servers, wherein the sensor is located in the rack.

6) The system of claim 1 further comprising, a liquid cooling unit that includes a pump for pumping fluid through the server and a valve for controlling fluid flow through the second fluid line.

7) The system of claim 1, wherein the first and second fluid lines each provide sufficient liquid coolant to cool heat generating components within the server.

8) A method, comprising:
sensing a fluid condition in order to detect a failure of a coolant flowing to cool a server;
adjusting fluid flow to the server in order to remedy the failure while maintaining the server online.

9) The method of claim 8 further comprising, sensing one of water temperature and water pressure as the fluid condition.

10) The method of claim 8 further comprising, connecting two different and independent fluid supply lines and fluid return lines to the server.

11) The method of claim 8 further comprising, opening a valve to switch from a first fluid supply line to a second fluid supply line upon sensing the failure.

12) The method of claim 8 further comprising:
pumping the coolant along a first supply line to the server before the failure;
pumping the coolant along a second supply line to the server after the failure.

13) The method of claim 8, providing redundant cooling to the server so the server does not overheat if one of two fluid supply lines coupled to the server fails.

14) A data center, comprising:
a server;
first and second liquid cooling lines providing redundant cooling to the server;
a sensor that senses a condition associated with at least one of the first and second liquid cooling lines to determine a failure and to activate an adjustment to one of the first and second liquid cooling lines so the server does not overheat.

15) The data center of claim 14, wherein the first and second liquid cooling lines are each connected to different supply and return lines within a building, the supply and return lines supplying liquid coolant to the server.

16) The data center of claim 14 further comprising, a first pump for pumping liquid coolant through the first liquid cooling line and a second pump for pumping liquid coolant through the second liquid cooling line, the second pump providing redundant pumping for the first pump.

17) The data center of claim 14, wherein the sensor senses one of temperature of liquid in the first and second liquid cooling lines and flow rate of liquid in the first and second liquid cooling lines.

18) The data center of claim 14, wherein the failure includes one of loss of pressure in the first or second liquid cooling lines and decrease in temperature of liquid in the first or second liquid cooling lines.

19) The data center of claim 14 further comprising, a modular unit that includes the sensor and a valve for opening and closing the second liquid cooling line.

20) The data center of claim 14, wherein the first liquid cooling line provides sufficient liquid coolant to cool heat generating components within the server when the second liquid cooling line fails, and the second liquid cooling line provides sufficient liquid coolant to cool the heat generating components within the server when the first liquid cooling line fails.
